(19) United States
(12) Patent Application Publication
(10) Pub. No.: US 2005/0176499 A1
(43) Pub. Date: Aug. 11, 2005

(54) Parimutual progressive pool controller

(75) Inventor: Andrew Stronach, Aurora (CA)

Correspondence Address: Mark A. Litman & Associates, P.A.;York Business Center, Suite 205, 3209 West 76th St., Edina, MN, 55435, US

(73) Assignee: ASIP Holdings, Inc.

(21) Appl. No.: 10/895,448

(22) Filed: Sep. 15, 2003

(51) Int. Cl. A63F 13/00

(52) U.S. Cl. 463/27

(57) ABSTRACT

A process builds a progressive wagering pool on a wagering race event that has multiple contestants and requires selecting multiple contestants in order or in combination to win a jackpot in the wagering race event. The process comprises increasing funding into the progressive wagering pool after an event has occurred based on wagers made on the event; automatically providing a potential winning combination in the jackpot to a user placing a wager from a first set of possible wagering combinations, automatically providing including a program that prioritizes combinations of contestants in a wager according to at least one of a) all individual contestants in a race event(s), b) betting odds on the wagering combinations, and c) all wagering combinations of contestants in a race event(s), the first set of wagering combinations excluding at least one level of priorities within a) or b) with a relative-to-the-field high estimation of winning a first race event(s); removing at least some levels of prioritized combinations and after increasing funding to the progressive pool has increased the pool, adding said at least one level of priorities with a relative-to-the-field high estimation of winning into wagering combinations available for a next wagering race event.

### BACKGROUND OG THE INVENTION

1. Field of the Invention

The present invention relates to wagering systems, particularly pari-mutuel wagering systems, and more particularly to controls exercised on progressive pools for pari-mutuel wagering.

2. Background of the Art

Pari-Mutuel wagering comprises a betting system in which the amount of money paid out to winners is based upon the total pool of bets. This is derived from an original form of wagering originated in 1865 by Frenchman Pierre Oller in which all money bet is divided up among those who have winning tickets, after taxes, takeout and other deductions are made. Oller called his system “parier mutuel” meaning “mutual stake” or “betting among ourselves.” As this wagering method was adopted in England it became known as “Paris mutuals,” and soon after “pari-mutuels.”

A pari-mutuel wagering system in today's technology based atmosphere is a complex, integrated hardware and software configuration that accepts wagers, prints bet tickets, calculates odds, and allows for the redemption of winning tickets. Transactions are processed at a rate of up to a thousand per second in a secure, redundant environment. Totalisator systems consist of the following components: The Central System—Central Systems consist of triplex redundant computers. Large communication arrays are linked to the central system, enabling the computers to process wagers from thousands of terminals at the local site and at hundreds of remote facilities. Proprietary Software—The software (such as Autotrak™ II software provided by Autotote, Inc.) has been developed over a period of 30 years. It supports multiple bet types, net pool pricing, player tracking, telephone, Internet wagering, and other advanced features. Newer systems, such as the ECLIPSE™ (Autotote, Inc.) totalisator processes transactions at an unprecedented pace per second—a vital advantage for real-time wagering and information processing. The integration of sophisticated database and Internet technologies offer customers both superior processing capacity and a continuous stream of data. There is also a client-defined data management tool in the system that swiftly renders these masses of data more understandable and usable. The Data Access System (or DAS) is a robust, intranet-based application providing access to real time data for use in analysis, performance tracking, tax processing and numerous other applications. Designed to work together in a cohesive and integrated manner, computer systems, terminals, peripheral devices and personnel provide superior technology and service to customers worldwide. There are numerous providers of terminals, software, and systems (e.g., Autotote, Amtote, Unitote, IQ-Ludorum, and others) to the gaming industry. Over 100,000 units are in service worldwide.

Flexibility and extensibility are key features of all modern terminals. The latest generation are PC-based terminals that use a common architecture, but different terminal packaging for different wagering venues. Applications include teller-based wagering, large group self-service wagering, table or small group self-service wagering, and personal wagering. Similarly, one type of terminal can use alternate software for different applications. One example is the EXTREMA™ terminal (Autotote, Inc.), which can be used for lottery, racing, and sports betting applications by installing different software and peripherals. Yet another example is Autotote's PROBE®XL, which can be used for a combination of gaming and racing.

Parimutuel or pari-mutuel race contestant wagering presently does not have a large instant payoff which can compete with a) state lotteries, b) national lotteries and c) progressive and interconnected slot-type gaming machines such as the “Megabucks” slot machines. One of the reasons for the inability to compete with slot machines is that slot machines that have very high odd random actuators and are linked together between machines. The probability of a jackpot event is fixed according to statistics and game controls, and portions of wagers are contributed to the jackpot pool over extended periods of times from many different machines. The highest paying wager for a pari-mutuel race contestant wagering today is the “Pick Six” wager based in California, programmed and operated by the totalizator company Autotote, Inc. However, this “Pick Six” wager requires the player to watch a race every half hour for six consecutive races which is very time consuming since people have to work during the day. Also, the “Pick Six” fails to have lottery sized pools because of consolation rules, whereby the wager will pay off the jackpot or pool with only four winners versus six winners. Therefore, there will be no progressive carryover if a player has four winners in six races, five winners in six races and, of course, a jackpot win with six winners in six races.

Also, in a Pick Six pari-mutuel event, a group of players can “box” and “key” race contestants via handicapping skills to further eliminate the chances of a progressive carryover to build the jackpot or betting pool for the next day. Since race contestant wagering is a game of skill via handicapping variables and not merely balls hopping with theoretically random occurrence out of a hopper, such as occurs in a lottery or a random actuator in a slot machine where reel probabilities can be predetermined by either physical mapping, software mapping, weighting or the like, so that probabilities can be specifically controlled within wide ranges of occurrence and frequency. Because the frequency in a slot machine is approximately truly random and can be programmed, it is substantially different from the frequency of a Pick Six pari-mutuel event being won. On the other hand, the jackpot or grand prize in a “pick six” wager or any exotic racing wager can be “busted” or won consistently at moderate award levels (thereby preventing progressive building) due to handicapping skill of narrowing the odds. If the grand prize or jackpot is greater than the possible combos of race contestants, one can “box the field” (make every conceivable wager) for a guaranteed jackpot win, thereby again eliminating any progressive carryover. For example, if the superfecta pool is $30,000 and there are only 24,024 combos in a 14 horse field (14×13×12×11=24,024) a player will be able to box the field for 24,024 different $1 combos since the jackpot is greater than the available combos (at least if there is a single winning ticket). Therefore, it is desirable and should have been considered by the industry to be able to create a wager where more potential combos (combinations) are involved such as picking the first 8 horses in exact order or 9 horses in exact order in another embodiment. (8 horses in exact order translates into 121,080,960 combos (14×13×12×11×10×9×8×7=121,080,960 combos) and 9 horses in exact order of a 14 horse field (a 14 horse field is used because this is the maximum race contestant field size without using an auxiliary gate for special races such as the Kentucky Derby and many tracks won't permit more than 14 horses for safety reasons) translates into 726,485,760 combos ([14!/6!] or 14×13×12×11×10×9×8×7×6=726,485,760 combos). Whatever the underlying reasons, this complexity of a wager has not been accepted by or promoted by the industry.

There are many different types of smaller wagers available to the player. EXACTA is a two horse bet, where one must pick the winner and second place finishers in exact order, or “box” the bet so that either order of first and second place wins the bet. NOTE: A player is able tom box most conventional and available wagers. When a player boxes a wager, all possible combinations of contestant wins, or limited numbers of contestant wins (a partial box) are wagered upon with multiple tickets or a special box ticket. For example, a $1.00 Exacta partial box of the contestants 1-2-3 will cost $6.00 (wagering $1.00 on each finish combination of 1-2-3; 1-3-2; 2-1-3; 2-3-1; 3-2-1; and 3-1-2, for six possible combinations at a cost per wager of $1.00). To determine the number of combinations possible in a box wager for an Exacta wager, the formula is: (# of Horses×(# of Horses-1) or in the example above, 3×2=$6.00. A 1-2-3-4 Exacta box=4×3=$12.00.

TRIFECTA is a three horse bet, where one must pick the winner, second, and third in exact order, or “box” the bet so that the three can finish in any order. The formula for a Trfiecta is mathematically similar: (# of Horses×(# of Horses−1)×(# of Horses-2). A 1-2-3 Trifecta box=(3×2×1=$6.00) and a 1-2-3-4 Trifecta box=(4×3×2=$24.00).

QUINELLA is a bet involving win and place (first and second) only. For example, to win a two horse QUINELLA bet both horses must run first or second, in either order. If a QUINELLA bet links a horse to several other horses, it must run first or second, and any of the other horses must run first or second.

SUPERFECTA is a four horse bet, where on must pick the first, second, third and fourth place horses in exact order, or “box” the bet so that four horses can finish in any of the first four places.

A KEY bet requires that you pick one horse to win, and several horses in any combination to complete the bet. For example, a $1 KEY trifecta with your selection to win plus 2 other horses (in any order) will cost $2. Your win horse with 3 other horses, $6. Your win horse with 4 other horses $12.

PICK THREE bets require that you select the winners in 3 consecutive races. There are also PICK FOUR, PICK SIX, and even PICK TEN (place bets, where your selections can finish either first or second). On Breeders Cup day the PICK SIX pool is several million dollars.

Some tracks have TWIN EXACTA and TWIN TRIFECTA bets, where one must pick an exacta or Trifecta in a designated race, then exchange that winning ticket (for which you get paid) to select the second exact or Trifecta in another designated race to win or share the betting pool. If there are no winners, the betting pool is carried forward to the next day. Mathematical formulae exist for determining the box bets for each of these forms of wagers.

There are numerous regulations that apply to the form and content of pari-mutuel wagering, pari-mutuel tickets, and pari-mutuel payouts. Typical of these are the content and definitions in a present Kansas State Regulation.

112-9-3. Parimutuel Wagering.

Each form of wagering shall be used only with permission of the commission and in accordance with the provisions of the Kansas parimutuel racing act. (Authorized by K.S.A. 1988 Supp. 74-8804 (p); implementing K.S.A. 1988 Supp. 8819(b); effective, T-112-3-31-89, Mar. 31, 1989; effective Jun. 26, 1989.)

112-9-4. Parimutuel Tickets.

(a) Each parimutuel ticket shall be evidence of a contribution to the parimutuel pool operated by the organization licensee and shall be evidence of the obligation of the organization licensee to pay to each holder the portion of the distributable amount of the parimutuel pool that is represented by each valid parimutuel ticket. Each organization licensee shall cash each valid, unmutilated winning ticket when each ticket is presented for payment during the course of the meeting where sold, and for a period of 60 days after the close of the race meeting.

(b) Each valid parimutuel ticket shall have been issued by a parimutuel ticket machine operated by the organization licensee and recorded as a ticket entitled to a share of the parimutuel pool, and contained imprinted information as to:
(1) The name of the organization licensee operating the meeting and the racetrack;
(2) the date of the wagering transaction and the date of the race;
(3) a unique identifying number or code;
(4) the race number for which the pool is conducted;
(5) the type or types of wager represented;
(6) the number or numbers representing the wagering interest for which the wager is recorded;
(7) the amount or amounts of the contribution to the parimutuel pool or pools for which the ticket is evidence; and
(8) the number of the ticket issuing machine.

(c) Each parimutuel ticket recorded or reported as previously paid, canceled or nonexistent shall be deemed an invalid parimutuel ticket by the organization licensee.

(d) Any organization licensee may withhold payment and may refuse to cash any parimutuel ticket deemed not valid. (Authorized by K.S.A. 1988 Supp. 74-8804 (p); implementing K.S.A. 1988 Supp. 74-8819; effective, T-112-3-31-89, Mar. 31, 1989; effective Jun. 26, 1989.)

One of the reasons that larger odds wagering has not been introduced to the racing industry (e.g., horse racing, dog racing, thoroughbred racing or harness racing) relates to the fact that the pari-mutuel racing industry is a heavily regulated industry. The pari-mutuel racing industry is controlled on a state-by-state basis via a state racing commission. However, there are some federal laws such as the Horse Racing Wire Act (this act allows wagers to cross state lines in order to commingle or share betting pools) but many of the model rules for racing such as racing dates, off track betting, medication and the introduction of a new bet type or new wager is regulated at the state level. Therefore, if one wanted to introduce a new national or international type of wager, it would have to be approved by the 42 states that have pari-mutuel wagering or any other international jurisdiction that wanted to participate in the commingled betting pool. The French-U.S. tax treaty permits commingling of pari-mutuel race contestant wagering between France and U.S. which was negotiated in the treaty. The more state racing commissions that adopt the new bet type or new wager, the greater the betting pool since distribution of the wager is increased by the access to more wagering locations and off-track betting web sites (e.g., racetracks and parlors). This increases the wagers' distribution. However, since a new bet type can be introduced only on a state-by-state basis, introducing a new bet type would result in high administrative and travel costs just to open “X” locations for distribution. Also, whenever introducing a new bet type, it takes time for public acceptance due to the learning curve of the new wager and also to create awareness that a new wager exists from a marketing perspective. It took six years to gain market wide acceptance and regulatory approval for the superfecta wager in 42 states.

Another reason why a 5, 6, 7, 8 or 9 race contestant wager in exact order is so difficult to implement is because it requires the results of more horses to be sent on the totalizator network which uses bandwidth and requires each host racing jurisdiction supplying simulcast races to record and monitor (photofinishes for example) extra race results requiring approval by (e.g., produced) the placing judges and stewards. Currently there are only results of the first four finishers available on the totalizator network since no more than four race contestants is required to complete of a bet type. (The superfecta bet type involves four race contestants which is the most results for any bet type relating to a specific race. Also, many players are tuned off by picking five or more contestants because they feel the risk is too great since many bettors have never even won a superfecta (4 contestant) let alone a wager with five or more contestants. Thereby it would be desirable to use only four numbers instead of five numbers from the psychological point of view where it is easier to pick four numbers instead of five numbers.

### SUMMARY OF THE INVENTION

A larger wagering pool for a progressive racing event is executed by a program that automatically selects combinations of entries or competitors for a wager, such as a superfecta or Pick Six event, particularly in a separate or closed pool event. By keeping the wagering event as a separate or closed pool and by requiring all combinations to be automatically selected by the system, a variable program is established that allows winning combination to be potentially selected early, but increases the likelihood of winning combinations being selected as the pool increases from continuing contributions to the pool by changing availability of lower odds contestants into the combination selection process as the pool increases in size. This graduated probability effect of excluding lower odds contestant(s) at lower pool content and then allowing greater selection of lower odds contestants as the pool increases in size increases the average size of final wagering pools in closes pool events.

### DETAILED DESCRIPTION OF THE INVENTION

As the superfecta presently is the highest paying wager one can play in a single race event (a “pick six winners” wager pays more but is very time consuming because it involves six races, which is very time consuming for the player who wants the immediate action such as a progressive Megabucks slot machine can do), it would be ideal to make a machine that only played superfectas for each available race in the simulcast menu in one embodiment that contained a “progressive pool controller.” A progressive pool controller is an algorithm embedded in hardware or software (on any processing system or format) that takes a specific number (e.g., “X”) of race contestants and creates only a specific second number (e.g., “Y” amount) of unique combos. Once those “Y” combos are used up or given away to players, the algorithm generates a new and separate pool and gives out the same combos from within the subset of “Y” combos over again. By limiting the number of combos to less than all available combos for a pool, and possibly by weighting combos for a certain number of events or for a certain amount of time within the group Y to those combos with a lower likely of occurrence (limiting the combos to lower probability events, the pool will increase more rapidly and a back-up or separate pool will begin that will be available when the first pool is won.

The progressive pool controller can operate in a number of modes which will be described herein. An example of one particular method will provide a basis for introduction to the generic concept. A handicapping database that is in the machine or accessed via a server determines (e.g., by handicapping methods known in the art, for example, those handicapping methods and concepts described in copending U.S. patent application Ser. No. 09/997,288 and PCT Application PCT CA02/01832, which references are herein incorporated by reference) which contestants are more likely to lose and are less likely to finish in the top four positions. The handicapping variables used in the algorithm, to name a non-limiting few would be time between races, trainer statistics, bullet track times, new additional equipment (new blinders, new tack), track conditions, change in competition category or class, weight changes, jockey record, change in jockey or trainer, etc. Many sophisticated handicappers today feel that it is easier to handicap contestants that are likely to lose, than it is to handicap contestants to win. Therefore, the pool controlling handicapping database supplies “X” number of horses that are the least likely for a high finish and supposedly will not finish in the top four of a combination of contestants wager, such as a superfecta, in one embodiment of a database for the selection process for determining the “Y” number of combos. The more losing combos given out in one event, the larger the jackpot will be due to carryovers. The algorithm will take this data and formulate unique combos to give the players, or when the unique combinations are exhausted repeat the combinations within the weakened pool or expand the combinations to continue providing unique combinations, yet still using reduced likelihood combinations. For example, if the first set of reduced likelihood combinations excluded the first four low odds contestants, when the combinations were exhausted, the algorithm, program or system, could then add the fourth lowest odds contestant into the available contestant pool for the algorithm, or even require that contestant to be used (to maintain uniqueness for the tickets and wagers), to expand the number of unique wagers available. For example, with fourteen contestants, and the first set of low probability wagers excluding the top four (lowest odds) contestants in the race, the addition of one more contestant (still without the top three contestants) would add over ten thousand new unique tickets to the available combo selection. It must be noted that even though the combinations are weighted in stages in favor of a growing pool, and this weighting can shift over time, any ticker always has the possibility of winning at any stage of the wagering events.

The players can receive their tickets through a “quick pick” play or an Enter Button in one embodiment. If the player chooses only play or enter, the player she will receive one unique combo for $1 or $2 (or whatever the wager event entry is) or the player may choose two or more unique combos by pressing a button with a denomination amount on it in one embodiment. For example, a player may choose $5 Play and receive five combos in one example, whereby a $1 to one combo ratio is used. Once all the unique combos are given out (if the database chooses eight contestants out of the fourteen in the race that supposedly shouldn't win this would result in (8×7×6×5×4×3×2×1=40320) low probability unique combos. A separate bet type pool is created for the same race event and the picks or combos that the handicapping system believes will have a low probability of winning or will lose are given out again, or the next lowest or another lowest odds contestant added to the set or contestants from which the combinations are made. For example, where the 1^{st} through 8^{th} highest odds of fourteen contestants have been used in the previous set of combinations to build the pool, the next set of combinations could add the 9^{th} highest odds contestant, the 10^{th} oth highest odds contestant, the 11^{th} highest odds contestant, or combination of these contestants 9 or higher ranked contestants up to the 14^{th} highest odds (the lowest odds) contestant, and still weight the pool, by leaving out other low odds contestants. Either the same pool of high odds candidates or a different pool of relatively high odds candidates will be provided, preferably until at least a threshold pool value is reached. The machine initially does handicap the selections for high probability winning combinations as it is not the initial intent of the program to give out winning picks or combos because this will bust the jackpot. Rather then just using the track odds or starting time odds or morning odds in the selection of the rank of the contestants, a handicapping system (such as those described above and incorporated by reference) can be used to rank the contestants and the order of selection can be based on the handicapping order, which can differ from the odds order.

The control over the selection of probabilities in the performance of the algorithm may be randomly performed or may itself be based upon an algorithm. For example, if the target average pool value at the time of a win is about $10,000,000, an algorithm can control the ‘proficiency’ of the handicapping by adjusting the selection performance or altering the scope of likely candidates that may be included. A wide variety of systems can effect this. For example, when the pool is below $1,000,000, the program and/or algorithm may exclude all candidates within a specific range of the lowest odds (e.g., the lowest three or four odds contestants in the race, either track odds and/or handicapped odds). When the pool is between $1,000,000 and $3,000,000, the algorithm or program may exclude all candidates within a different range of the lowest odds, such as the 1^{st} lowest, second lowest and 4^{th} lowest odds. When the pool is between $3,000,000 and $5,000,000, the algorithm or program may again be altered, for example, with the algorithm/program candidate base eliminating another set of candidates within a specific range such as the 1^{st} lowest odds candidate, the 3^{rd} lowest odds candidate, and the 4^{th} lowest odds candidates. The progression of allowing the use of lower odds candidates can progress to the point where the algorithm/program is attempting t handicap a winner without any restrictions on the available candidates. The system may alternatively be triggered from a fixed algorithm (that limits available candidates based upon their likelihood of finishing well in a race) to a universal base (all candidates or at least the highest ranked candidates are available, with handicapping to win functions in the program) when a threshold pool level is reached, for example, the arbitrarily selected $10,000,000 value. The switch to the more favorably handicapping pool of contestants and handicapping to win algorithms does not mean that the pool will be won when this is effected, any more than the somewhat rigid and unfavorable pool of candidates means that a player cannot win. Only the probabilities are adjusted, not the certainty of events.

The reason why only unique combos would be given out is because two tickets that used the same race contestant numbers would have to split the jackpot which could annoy or disappoint the player, since the jackpot or pool would have to be split. (Slot machines such as Megabucks only have one winner for the entire jackpot, but that is assured because each machine operates uniquely in time and the jackpot is won only when the first winning combination occurs. This is in contrast to a race event where multiple identical wagers could otherwise be placed on the same event.). Since in this example there are only 40320 unique combos (and with only the six highest odds contestants selected there would be only 720 combinations) available, a new betting pool or backup betting pool could be created such as a new superfecta pool in this example that would be guaranteed by insurance or in-house marketing dollars. The new pool with unique combos could be assured by dropping candidates from the first pool and adding new candidates into the second pool, and having the algorithm exclude any combos that include only previously available candidates (e.g., the algorithm could require that at least one ‘new’ candidate be included in the combos for the second pool). Even though, not previously mentioned, the first pool would be insured by in-house dollars or insurance as well and if a 3^{rd} or more pools are required in the future these pools would be insured for a greater prize as well, such as 1,000,000 dollars in one example. Insurance is required since a $720 pool in this example is not a big enough jackpot. The pool could be seeded or insured by the house/track/administrator to assure that at least a minimum pool would be available, with the exposure being reduced as the play of the wager diminished the shortfall of wager contributions to the pool. In other words, what track management is doing is insuring that these longshots or “X” race contestants that the database chose within the “Y” combinations won't win, otherwise in-house dollars or insurance would have to “cough it up” or provide the winning jackpot of $ 1,000,000 in this example to the players who had this unique combo. The likelihood of a loss before the pool is funded is quite small because of the handicapping towards unlikely outcomes.

There would be one winning combo for a “sold out” pool and there may be a winning unique combo in a pool that isn't sold out if a player were lucky enough to have the correct numbers or be given a correct combo even though every unique combo wasn't given out. In other words, this algorithm is trying to constantly build jackpots or pools progressively by picking contestants with unfavorable handicapping variables. If the database is successful in giving away 2,000,000 losing combos over a period of time (with a fifty percent contribution to the pool), the jackpot will now be a $1,000,000 without insurance required. Since players get discouraged if they see that nobody is winning this wager, the handicapping database would work in reverse and only choose contestants that it believes will finish in the top four in this example to “bust” the jackpot. “Busting” or giving away the jackpot especially for at least $1,000,000 in this example is good from a marketing perspective as news like this travels to other players. Therefore, one could build jackpots from a marketing perspective to create excitement and then “bust” the jackpot to show the public that the jackpot is achievable.

The algorithm may also randomly allow for quality handicapping to be performed (which will still never guarantee a winner, unless all possible combinations [14! combinations] are used) so that over time, some jackpot pools will be won below the target threshold to stimulate continued wagering on the system as the pool builds.

By the practice of this invention, the progressive pools can be reasonably and fairly controlled through handicapping like “turning a light switch on and off” or at least dimming the light by weighting, shifting or reversing the handicapping formulas via an algorithm. This is a controlled environment because the players cannot pick their own race contestants or let alone key or wheel their race contestants to “bust” the betting pool or jackpot. The players can receive combos or numbers that the algorithm chooses to do so. The players can have no independent selection capability in designing or selecting combinations, and the pool must be closed to include only automated picks using the system, processors and algorithms of the invention. The touch screen or other user interface is “inactive” in regards to choosing race contestants on a machine or website in one type of emodiment for hardware.

Once the handicapping formula determines which contestants are to be excluded in the weighted non-favorable combination pools, either by odds alone (whether by morning odds, opening odds, start odds, etc.) or the order is determined by use of handicapping variables and odds feed provided by a totalizator company such as Amtote, the progressive pool controller will rank the highest odd or least likely combo to lowest odd or more likely combo available among “X” race contestants. By doing this, it increases the chances of building the pool since the worst picks or combos are given out first and the most likely combos at the very end whereby the very most likely combo is given at the very end.

The algorithms used in the practice of the present invention can be fundamentally simple. For ease of discussion, the numbers of the contestants (1-14) will be based upon their favorable odds (e.g., 1 has the lowest odds, 2 has the second lowest odds, and 14 has the highest odds). Among the various non-limiting examples would be, based on fourteen contestants in each race for exemplary purposes:

### EXAMPLE I

This example will be based on an approximate attempt to assure average pool sizes over $2,000,000.

Pool less then $500,000, contestants 5-14 only, will be allowed in the contestant pool.

Pool between $500,000-$750,000, contestants 4-14 only, will be allowed in the contestant pool.

Pool between $750,000-$1,000,000, contestants 3-14 only, will be allowed in the contestant pool.

Pool between $1,000,000-$1,250,000, contestants 2-12 only, will be allowed in the contestant pool.

Pool between $1,250,000-$1,500,000, contestants 2-10 only, will be allowed in the contestant pool.

Pool between $1,500,000-$1,750,000, contestants 1 and 4-14 only, will be allowed in the contestant pool.

Pool between $1,750,000-$2,000,000, contestants 1, 2, and 4-12 only, will be allowed in the contestant pool.

Pool between $2,000,000-$2,250,000, contestants 1-3 and 5-12 only, will be allowed in the contestant pool.

Pool above 2,250,000, contestants 1-14 inclusive, will be allowed in the contestant pool.

### EXAMPLE II

This example will be based on an approximate attempt to assure average pool sizes over $5,000,000.

Pool less then $500,000, contestants 6-14 only, will be allowed in the contestant pool.

Pool between $500,000-$1,000,000, contestants 5-14 only, will be allowed in the contestant pool.

Pool between $1,000,000-$1,500,000, contestants 4-14 only, will be allowed in the contestant pool.

Pool between $1,500,000-$2,000,000, contestants 3-12 only, will be allowed in the contestant pool.

Pool between $2,000,000-$2,500,000, contestants 3-10 only, will be allowed in the contestant pool.

Pool between $2,500,000-$3,000,000, contestants 2 and 4-12 only, will be allowed in the contestant pool.

Pool between $3,000,000-$3,500,000, contestants 1 and 4-12 only, will be allowed in the contestant pool.

Pool between $3,500,000-$4,000,000, contestants 1-2 and 5-14 only, will be allowed in the contestant pool.

Pool between $4,000,000-$4,500,000, contestants 1-2 and 4-13 only, will be allowed in the contestant pool.

Pool between $4,500,000-$5,000,000, contestants 1 and 3-14 only, will be allowed in the contestant pool.

Pool above 5,000,000, contestants 1-14 inclusive, will be allowed in the contestant pool, with weighting being favored or allowed towards contestants with higher possibilities of winning.

The algorithms may act in combination with random number generators in the following manner. Once the complete set of available combos has been determined (e.g., there are 14!-4! available), each wager will randomly be assigned a single one of the available combos (including both high probability wagers and low probability wagers), withdrawing one combination at a time from the pool to assure uniqueness of each ticket. If the entire pool of combinations has been exhausted, the complete pool or a partial pool (including a weighted pool, either favorably, negatively or mid-range) can be used to provide additional combinations that would duplicate already distributed combinations, which would mean that a split pot is possible, but the number of splits is minimized by again having the second series of issued combinations being unique within the second set.

The pool is funded by wagers on the specific event and or by other contributions from the tracks or system. The economics of race wagering are quite complex and there are many distribution points of value in the system, which offers significant numbers of ways in which the pool will build. Although the following numbers are not intended to be absolute in terms of value flow, they are realistically illustrative of the kinds of flow and the distribution of value from which the pool may be funded.

In regular direct wager, single race events, on each wager (e.g., a Place wager), 85% may go into the wager pool, 8% may go to the trainers/owners/stakes, 3% may go to the track, and 2% may go to the totalisator provider. The distribution on superfecta wagers or other multiple pick wagers may shift away from trainers/owners/stakes so that the distribution is more like 2% trainers/owners, 4% to the track and 2% to the totalisator system, with as much as 92% therefore going to the pool. With the present system, it is possible that the trainers and owners can be eliminated from the distribution and the take of the track reduced (as the overall amount may be significantly increased by wagering occurring at numerous tracks), so that the pool contribution could be from 92% to 96% or higher, with other reductions. It is easily possible to have contributions of from at least 80% or at least 85% up to 92%, 94%, 96% or higher (in introductory periods, the pool could receive 100%, even) into the pool from each wager, and even have separate contributions from other wagers. Thus, the pool can be fed directly from wagers on the progressive bet, with a fixed percentage or floating percentage of all wagers going into the progressive jackpot pool, and/or the pool may be supplemented by tracks entering into the original pool, or wagering establishments entering into the original pool. It is possible, but undesirable, to allow new establishments to join into existing pools, especially with the variable algorithms and grading of probabilities done on the combinations.

The invention may also be described as a process or a terminal enabling the process through a processor, wherein the process is for building a progressive wagering pool on a wagering race event that has multiple contestants and requires selecting multiple contestants in order or in combination to win a jackpot in the wagering race event. The process comprises i) increasing funding into the progressive wagering pool after an event has occurred based on wagers made on the event; ii) automatically providing a potential winning combination in the jackpot to a user placing a wager from a first set of possible wagering combinations, automatically providing including a program that prioritizes combinations of contestants in a wager according to at least one of
a) all individual contestants in a race event(s),
b) betting odds on the wagering combinations, and
c) all wagering combinations of contestants in a race event(s),
the first set of wagering combinations excluding at least one level of priorities within a) or b) with a relative-to-the-field high estimation of winning a first race event(s), iii) removing at least some levels of prioritized and iv) after increasing funding to the progressive pool has increased the pool, adding said at least one level of priorities of the combination with a relative-to-the-field high estimation of winning into wagering combinations available for a next wagering race event. It is preferred that all combinations of contestants are prioritized. The process may be selected, by way of non-limiting examples, from the group consisting of a) at least a second race event; b) at least a minimum number of wagers having been placed on race events contributing to the wagering pool; c) at least a minimum amount of money wagered on race events contributing to the wagering pool; d) a number of race events that have been wagered on that contribute to the wagering pool without a wager winning the wagering pool; and e) a minimum amount of money in the wagering pool. By the term “level of priorities” is included at least one and possibly more of higher likelihood events. For example, if the order of selections are based on track odds with 1000 possible combinations statistically available that are listed in decreasing order of probability (e.g., 1=highest probability event and 1000=the lowest probability event), various non-limiting examples of a level of priority that could be excluded from initial wagering selections to increasing the likelihood of increasing the pool could be the level of combinations 1-20; combinations of 1-10 and 15-20; combinations of 1-5 and 10-15 and 20-25; combinations of 1-3 and 8-12 and 16-20; and the like. The same type of distribution may be used in contemplating lists, prioritized orders and the like based on handicapped priorities.

These and other aspects of the invention that have been discussed are non-limiting examples of the generic scope of the invention. Alternatives, extensions, and equivalents may be used. The processor system may be centrally located to permit general track9s) access, the processor may be local and exclusive to a single track (with the pool closed to that track), handicapping systems, computer formats (PC, Mac, Linux, UNIX, etc.), and software and algorithm bases.

The above description has used many specific examples and specific numbers in providing a non-limiting description of the invention. It should be apparent and is intended to be understood by those skilled in the art that alternatives to these specific examples may be used within the scope of the invention. The particular games described may be accessed, uploaded or downloaded on demand into terminals or PC's through information transmission (wired or wireless) to the wagering sites. This may be by I.P. broadcasting or multitasking with appropriate transmission security applied (e.g., encryption verification, encoding, secure lines, secure encoded signals, and the like. IP (Internet Protocol) is used to refer to a group of emerging technologies that are reshaping the landscape of every industry involved with mass communications. Enabled by the IP concept, the Internet has emerged as a massive threat to TV, radio, cable, DBS and other broadcast distribution infrastructures. TCP and IP were developed by a Department of Defense (DOD) research project to connect a number of different networks designed by different vendors into a network of networks (the “Internet”). It was initially successful because it delivered a few basic services that everyone needed (file transfer, electronic mail, remote logon) across a large number of client and server systems. TCP/IP is composed of layers. IP is responsible for moving packets of data from node to node. IP forwards each packet based on a four-byte destination address (the IP number). The Internet authorities assign ranges of numbers to different organizations. The organizations assign groups of their numbers to departments. IP operates on gateway machines that move data from department to organization to region and then around the world. TCP is responsible for verifying the correct delivery of data from client to server, as data can be lost in the intermediate network. TCP adds support to detect errors or lost data and to trigger retransmission until the data is correctly and completely received.

TCP/IP is not a broadcast technology. It is a one-to-one packet-based communications protocol designed for the reliable delivery of data across interconnected networks. Digital broadcasting, on the other hand, is a one-to-many stream-based technology designed for the isochronous delivery of data across a variety of competing, largely non-interconnected networks. This is particularly applicable to wagering terminals where it is desirable to provide different wagering games to the terminals or to personal home computers or wagering sites.

Isochronous means that the data packets within a stream must be delivered on time and that the network must provide guaranteed bandwidth to support the peak bit-rate requirements of the content that is being delivered—typically audio and video streams. If the data does not arrive on time or it is corrupt, too bad—there are no second chances with real-time broadcast streams. This is uniquely critical in the wagering environment to have the information delivered in a timely manner. There are commercially available systems (e.g., SMPTE 259M (SDI) to move digital video through the routing switchers found in modern video facilities, and the MPEG-2 transport protocol is optimized for the delivery of compressed digital video streams) that are the transport layers of choice for digital cable, DBS and DTV broadcasting around the world. The benefit of IP Broadcasting is becoming obvious as the worlds of mass media broadcasting and the Internet collide. TCP/IP has become the language of peer-to-peer digital networking. It is found at the transport layer for the Ethernet networks that link computers together in offices and homes worldwide. And it is the transport layer for cable modems and digital subscriber lines, the broadband pipes that threaten to deliver mass media content on demand, to anyone, anywhere, anytime.

1. A process for building a progressive wagering pool on a wagering race event that has multiple contestants and requires selecting multiple contestants in order or in combination to win a jackpot in the wagering race event, the process comprising:
increasing funding into the progressive wagering pool after an event has occurred,
ordering contestants in each wagering race event on which a wager may be placed to win the wagering pool, the ordering being done with regard to at least one form of estimating likelihood of position finish within the race event,
automatically providing a potential winning combination in the jackpot to a user placing a wager from a first set of possible wagering combinations, the first set of wagering combinations excluding at least one level of contestant with a relative-to-the-field high estimation of winning a first race event, and
after increasing funding to the progressive pool has increased the pool, adding said at least one level of contestant with a relative-to-the-field high estimation of winning into contestants available for a next wagering race event.

2. The process of claim 1 wherein the ordering is based at least in part on ordering contestants according to betting odds.

3. The process of claim 1 wherein the ordering is based at least in part on ordering contestants according to handicapping of contestants.

4. The process of claim 2 wherein contestants in the first race wagering event are placed into at least an approximate order based on respective betting odds on the contestants and at least two of the first three contestants in the order with the lowest odds are excluded from the first set of wagering contestants.

5. The process of claim 3 wherein contestants in the first race wagering event are placed into at least an approximate order based on respective betting odds on the contestants and at least two of the first three contestants in the order with most favorable handicaps are excluded from the first set of wagering contestants.

6. The process of claim 4 wherein there is at least one threshold event for the progressive wagering pool that adding said at least one level of contestant with a relative-to-the-field high estimation of winning into contestants available for a next wagering race event occurs.

7. The process of claim 5 wherein there is at least one threshold event for the progressive wagering pool that adding said at least one level of contestant with a relative-to-the-field high estimation of winning into contestants available for a next wagering race event occurs.

8. The process of claim 6 wherein said threshold event comprises wagering pool size.

9. The process of claim 7 wherein said threshold event comprises wagering pool size.

10. The process of claim 6 wherein said threshold event comprises number of race events wagered upon that contribute to the pool.

11. The process of claim 7 wherein said threshold event comprises number of race events wagered upon that contribute to the pool.

12. A progressive wagering pool terminal from which wagers may be made on a progressive jackpot based on correct selection of multiple contestants in race events, wherein all wagers made on the progressive jackpot are automatically provided to users by a processor, and wherein the processor operates to:
order contestants or groups of contestants in each wagering race event on which a wager may be placed to win the wagering pool, the ordering being done with regard to at least one form of estimating likelihood of position finish within the race event,
automatically provide a potential winning combination in the jackpot to a user;
place a wager from a first set of possible wagering combinations, the first set of wagering combinations excluding at least one level of contestant with a relative-to-the-field high estimation of winning a first race event, and
after increasing funding to the progressive pool has increased the pool, add said at least one level of contestant with a relative-to-the-field high estimation of winning into contestants available for a next wagering race event.

13. The terminal of claim 12 wherein the ordering is based at least in part on ordering contestants according to betting odds.

14. The terminal of claim 12 wherein the ordering is based at least in part on ordering contestants according to handicapping of contestants.

15. The terminal of claim 13 wherein contestants in the first race wagering event are placed into at least an approximate order based on respective betting odds on the contestants and at least two of the first three contestants in the order with the lowest odds are excluded from the first set of wagering contestants.

16. The terminal of claim 14 wherein contestants in the first race wagering event are placed into at least an approximate order based on respective betting odds on the contestants and at least two of the first three contestants in the order with most favorable handicaps are excluded from the first set of wagering contestants.

17. The terminal of claim 15 wherein there is at least one threshold event for the progressive wagering pool that adding said at least one level of contestant with a relative-to-the-field high estimation of winning into contestants available for a next wagering race event occurs.

18. The terminal of claim 16 wherein there is at least one threshold event for the progressive wagering pool that adding said at least one level of contestant with a relative-to-the-field high estimation of winning into contestants available for a next wagering race event occurs.

19. The terminal of claim 17 wherein said threshold event comprises wagering pool size.

20. The terminal of claim 18 wherein said threshold event comprises wagering pool size.

21. The terminal of claim 17 wherein said threshold event comprises number of race events wagered upon that contribute to the pool.

22. The terminal of claim 18 wherein said threshold event comprises number of race events wagered upon that contribute to the pool.

23. The terminal of claim 12 wherein the terminal does not allow certain race contestants in a specific race to be wagered upon in a multiple contestant wager event even though a player may officially wager on that contestant via another network or machine.

24. A process for building a progressive wagering pool on a wagering race event that has multiple contestants and requires selecting multiple contestants in order or in combination to win a jackpot in the wagering race event, the process comprising:
increasing funding into the progressive wagering pool after an event has occurred based on wagers made on the event;
automatically providing a potential winning combination in the jackpot to a user placing a wager from a first set of possible wagering combinations, automatically providing including a program that prioritizes combinations of contestants in a wager according to at least one of a) all individual contestants in a race event(s), b) betting odds on the wagering combinations, and c) all wagering combinations of contestants in a race event(s), the first set of wagering combinations excluding at least one level of priorities of combinations within a) or b) with a relative-to-the-field high estimation of winning a first race event(s),
removing at least some levels of prioritized and
after increasing funding to the progressive pool has increased the pool, adding said at least one level of priorities with a relative-to-the-field high estimation of winning into wagering combinations available for a next wagering race event.

25. The process of claim 24 wherein all combinations of contestants are prioritized.

26. The process of claim 25 wherein the event is selected from the group consisting of a) at least a second race event; b) at least a minimum number of wagers having been placed on race events contributing to the wagering pool; c) at least a minimum amount of money wagered on race events contributing to the wagering pool; d) a number of race events that have been wagered on that contribute to the wagering pool without a wager winning the wagering pool; and e) a minimum amount of money in the wagering pool.

27. A wagering terminal that accesses a processor that performs the process of claim 25.

28. A wagering terminal that accesses a processor that performs the process of claim 26.
